(19) United States
(12) Patent Application Publication
(10) Pub. No.: US 2015/0302549 A1
(43) Pub. Date: Oct. 22, 2015

(54) INFORMATION PROCESSING SYSTEM, CONTROL METHOD AND COMPUTER-READABLE MEDIUM

(71) Applicants: NEC Corporation, Tokyo (JP); NEC Solution Innovators, Ltd., Tokyo (JP)

(72) Inventors: Noriyoshi HIROI, Tokyo (JP); Yoshiaki SATO, Tokyo (JP); Nobuaki TAKANASHI, Tokyo (JP); Hiroyuki WATANABE, Tokyo (JP); Takafumi KUROKAWA, Tokyo (JP); Ryohtaroh TANIMURA, Tokyo (JP); Kenji AKIYOSHI, Tokyo (JP)

(73) Assignees: NEC Corporation, Tokyo (JP); NEC Solution Innovators, Ltd., Tokyo (JP)

(21) Appl. No.: 14/689,253

(22) Filed: Apr. 17, 2015

(30) Foreign Application Priority Data
Apr. 18, 2014 (JP) 2014-086510

(51) Int. Cl. G06T 3/00; G06T 7/20; G06T 1/00; G06T 7/00; G06T 3/40; G06T 3/60

(52) U.S. Cl. CPC G06T 3/0006; G06T 3/40; G06T 3/60; G06T 1/0007; G06T 7/0057; G06T 7/0085; G06T 7/20; G06T 2207/10028; G06T 2207/20104

(57) ABSTRACT

An information processing system, method and non-transitory computer-readable storage medium are disclosed. The information processing system may include a memory storing instructions; and at least one processor configured to process the instructions to detect an actual object, determine at least one of an orientation and a position of a first image within a projection surface, based on at least one of an orientation and a position of the actual object, and project the first image onto the projection surface in at least one of the determined position and determined orientation.

### CROSS-REFERENCE TO RELATED PATENT APPLICATION

This application is based upon and claims the benefit of priority from Japanese Patent Application No. 2014-086510, filed on Apr. 18, 2014, the disclosure of which is incorporated herein in its entirely by reference.

### BACKGROUND

1. Technical Field

The present disclosure generally relates to an information processing system, a control method and a program.

2. Description of the Related Art

Digital signages that advertise media for displaying images and information using display devices, projectors, and the like may have been known. Some digital signages may be interactive in that their displayed contents are changed in accordance with the operations of users. For example, there may be a digital signage in which, when a user points at a marker in a brochure, contents corresponding to the marker are displayed on a floor or the like.

In digital signages presenting information by projecting images, it may be important to project images in a state of the image that is easy to handle for the user. The state of the image that is easy to handle for the user may depend on conditions of a projection surface, on which the image is to be projected, or its surroundings (e.g., the user's situation). For example, an image displayed in a position distant from the user and an image displayed at an angle that makes it difficult for the user to view the image may be difficult for the user to handle. The related art selects a projection surface, when there is more than one projection surface, in accordance with a position of a user. However, the related art may not determine a state of an image to be projected in accordance with conditions of the projection surface or its surroundings.

### SUMMARY OF THE DISCLOSURE

Exemplary embodiments of the present disclosure may solve one or more of the above-noted problems. For example, the exemplary embodiments may provide a technology to project an image easy for a user to handle. According to a first aspect of the present disclosure, an information processing system is disclosed. The information processing system may include a memory storing instructions; and at least one processor configured to process the instructions to detect an actual object, determine at least one of an orientation and a position of a first image within a projection surface, based on at least one of an orientation and a position of the actual object, and project the first image onto the projection surface in at least one of the determined position and determined orientation.

An information processing system according to another aspect of the present disclosure may include a memory storing instructions, and at least one processor configured to process the instructions to project a first image onto a projection surface, detect a user operation, determine an orientation of the first image, based on a movement direction of a position on which the first image is projected.

An information processing method according to another aspect of the present disclosure may include detecting an actual object, determining at least one of an orientation and a position of a first image within a projection surface, based on at least one of an orientation and a position of the actual object, and projecting the first image onto the projection surface in at least one of the determined position and determined orientation.

An information processing method according to another aspect of the present disclosure may include projecting a first image onto a projection surface, detecting a user operation, determining an orientation of the first image, based on a movement direction of a position on which the first image is projected.

A non-transitory computer-readable storage medium may store instructions that when executed by a computer enable the computer to implement a method. The method may include detecting an actual object, determining at least one of an orientation and a position of a first image within a projection surface, based on at least one of an orientation and a position of the actual object, and projecting the first image onto the projection surface in at last one of the determined position and determined orientation.

A non-transitory computer-readable storage medium may store instructions that when executed by a computer enable the computer to implement a method. The method may include projecting a first image onto a projection surface, detecting a user operation, determining an orientation of the first image, based on a movement direction of a position on which the first image is projected.

In certain embodiments, the information processing system, the control method, and the computer-readable medium may provide a technology to project an image easy for a user to handle.

### BRIEF DESCRIPTION OF THE DRAWINGS

FIG. 1 is a block diagram illustrating an information processing system of a first exemplary embodiment.

FIG. 2 is a block diagram illustrating a hardware configuration of the information processing system.

FIG. 3 is a diagram illustrating an example of a device including a combination of the projection device and the monitoring device.

FIG. 4 is a flowchart depicting a flow of processing executed by the information processing system of the first exemplary embodiment.

FIG. 5 is a diagram illustrating a usage environment of the information processing system of a first example.

FIG. 6A and FIG. 6B are plan views illustrating a table in front of a user.

FIG. 7 is a block diagram illustrating an example of an information processing system.

FIG. 8A and FIG. 8B are diagrams for illustrating an orientation of a content image.

FIG. 9 is a diagram illustrating a method for determining the orientation of the content image based on a major axis direction of the user's body.

FIG. 10 is a diagram illustrating a method for determining an orientation of a first image.

FIG. 11 is a diagram illustrating how the content image is projected in accordance with an extending direction of the user's finger.

FIG. 12 is a block diagram illustrating an information processing system of a second exemplary embodiment.

FIG. 13 is a diagram illustrating an edge detected by an edge detection unit.

FIG. 14 is a diagram illustrating respective edges of a tray with a mark.

FIG. 15 is a diagram illustrating relationships between positions of the trays and the respective edges on a table.

FIG. 16 is a flowchart depicting a flow of processing executed by the information processing system of the second exemplary embodiment.

FIG. 17A and FIG. 17B are diagrams illustrating a situation on a table in a second example.

FIG. 18 is a diagram illustrating processing performed by a state determination unit of a third exemplary embodiment.

FIG. 19 is a block diagram illustrating an information processing system of a fourth exemplary embodiment.

FIG. 20 is a diagram illustrating processing executed by a direction determination unit.

FIG. 21 is a diagram illustrating a relationship between a movement direction of a content image and an orientation of the content image in the movement direction.

FIG. 22 is a diagram illustrating a method for determining the orientation of the content image using an average movement speed.

FIG. 23 is a flowchart depicting a flow of processing executed by an information processing system of the fourth exemplary embodiment.

### DETAILED DESCRIPTION

Hereinafter, embodiments of the present disclosure will be described with reference to the accompanying drawings. Wherever possible, the same reference numbers will be used throughout the drawings to refer to the same or like parts.

### First Exemplary Embodiment

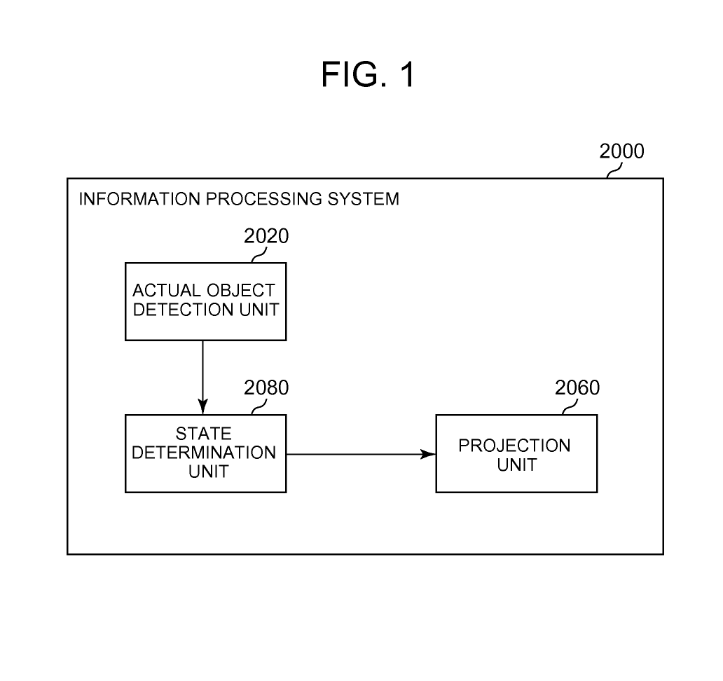

FIG. 1 is a block diagram illustrating an information processing system 2000 of a first exemplary embodiment. In FIG. 1, solid arrows may indicate a flow of information, while dotted arrows may indicate a flow of energy. Each block in FIG. 1 may not indicate the configuration of a hardware unit, but may indicate the configuration of a functional unit.

The information processing system 2000 may include an actual object detection unit 2020, a projection unit 2060, and a state determination unit 2080. The actual object detection unit 2020 may detect an actual object. The actual object may be the entirety of an actual object or a part of an actual object. The projection unit 2060 may project a first image onto a projection surface. The projection unit 2060 may project one or more the first image. The state determination unit 2080 may determine at least one of an orientation of the first image and a position thereof within the projection surface, based on at least one of an orientation and a position of the detected actual object. In some aspects, the projection unit 2060 may project the first image in the position or orientation determined by the state determination unit 2080.

### Hardware Configuration

The respective functional components of the information processing system 2000 may be realized by hardware components (e.g., hard-wired electronic circuits and the like) to realize the functional components, or may be realized by a combination of hardware components and software components (e.g., a combination of electronic circuits and a program to control those circuits, and the like).

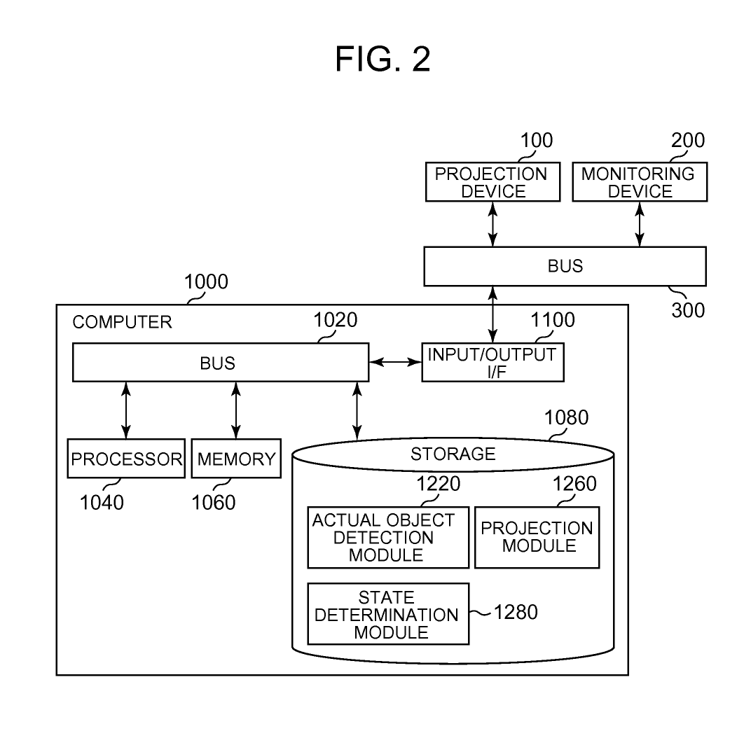

FIG. 2 is a block diagram illustrating a hardware configuration of the information processing system 2000. In FIG. 2, the information processing system 2000 may be realized with a projection device 100, a monitoring device 200, a bus 300, and a computer 1000. The projection device 100 may project an image. The projection device 100 may be a projector, for example. The monitoring device 200 may monitor its surroundings. The monitoring device 200 may be a camera for example. The computer 1000 may be any of various types of computers, such as a server and a PC (Personal Computer). The bus 300 may include a data transmission path through which data is transmitted and received among the projection device 100, the monitoring device 200, and the computer 1000. In some aspects, the connection among the projection device 100, the monitoring device 200, and the computer 1000 to each other may not be limited to the bus connection.

In some aspects, external input devices may be further connected to the bus 300. Examples of such external input devices may include a wireless mouse, a remote, a reader that reads an RF (Radio Frequency) tag, and a reader that reads an NFC (Near Field Communication) IC chip or the like.

### Details of Computer 1000

In certain aspects, the computer 1000 may include a bus 1020, a processor 1040, a memory 1060, a storage 1080, and an input/output interface 1100. The bus 1020 may include a data transmission path through which data is transmitted and received among the processor 1040, the memory 1060, the storage 1080 and the input/output interface 1100 to and from each other. In some aspects, the connection among the processor 1040 and others each other may not be limited to the bus connection. In some instances, the processor 1040 may include an arithmetic processing unit such as a CPU (Central Processing Unit) and a GPU (Graphics Processing Unit). In other instances, the memory 1060 may include a memory such as a RAM (Random Access Memory) and a ROM (Read Only Memory). In other instances, the storage 1080 may include a storage device such as a hard disk, an SSD (Solid State Drive) and a memory card. In other aspects, the storage 1080 may be a memory such as a RAM and a ROM. The input/output interface 1100 may include an input/output interface to transmit and receive data between the projection device 100 and the monitoring device 200 through the bus 300. The input/output interface 1100 may include a network interface for connecting to a network. The network may be realized by a wired line, a wireless line or a combination thereof.

The storage 1080 may store an actual object detection module 1220, a projection module 1260 and a state determination module 1280 as programs for realizing the functions of the information processing system 2000.

The actual object detection unit 2020 may be realized by a combination of the monitoring device 200 and the actual object detection module 1220. In some aspects, the actual object detection module 1220 may detect the actual object by obtaining and analyzing an image captured by the monitoring device 200. The actual object detection module 1220 may be executed by the processor 1040.

The projection unit 2060 may be realized by a combination of the projection device 100 and the projection module 1260. In some instances, the projection module 1260 may transmit information indicating a combination of “an image to be projected and a projection position onto which the image is projected” to the projection device 100. The projection device 100 may project the image on the basis of the information. The projection module 1260 may be executed by the processor 1040.

The processor 1040 may realize the function of the state determination unit 2080 by executing the state determination module 1280.

In some aspects, the processor 1040 may execute the modules after reading the modules onto the memory 1060 or may execute the modules without reading the modules onto the memory 1060.

The hardware configuration of the computer 1000 may not be limited to that illustrated in FIG. 2. In some aspects, the respective modules may be stored in the memory 1060. Further, the computer 1000 may not have to include the storage 1080.

### Details of Projection Device 100 and Monitoring Device 200

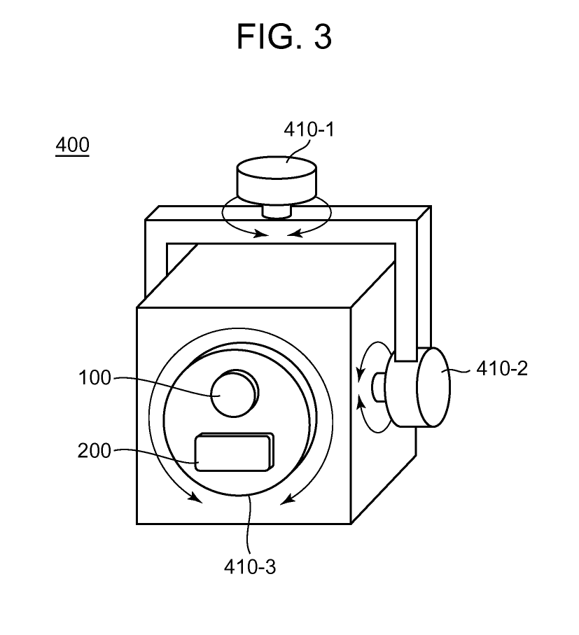

FIG. 3 is a diagram illustrating a device 400. The device 400 illustrated in FIG. 3 may include the projection device 100, the monitoring device 200, and a projection direction adjustment unit 410. The projection direction adjustment unit 410 may include a combination of projection direction adjustment units 410-1, 410-2 and 410-3. In some aspects, the projection direction of the projection device 100 may coincide with or differ from the monitoring direction of the monitoring device 200. In other aspects, a projection range of the projection device 100 may coincide with or differ from a monitoring range of the monitoring device 200.

In some aspects, the projection device 100 may be a visible light projection device or an infrared projection device, and may project an arbitrary image onto a projection surface by outputting light representing predetermined patterns or characters or any patterns or characters.

In some aspects, the monitoring device 200 may include one of or combination of more than one of a visible light camera, an infrared light camera, a range sensor, a range recognition processing device and a pattern recognition processing device. In some aspects, the monitoring device 200 may be a combination of a camera, which is used for photographing spatial information in the forms of two-dimensional images, and an image processing device, which is used for selectively extracting information regarding an object from these images. Further, an infrared light pattern projection device and the infrared light camera may obtain spatial information on the basis of disturbances of patterns and the principle of triangulation. Additionally and alternatively, the monitoring device 200 may obtain information in the direction of depth, as well as planar information, by taking photographs from plural different directions. Further, in some aspects, the monitoring device 200 may obtain spatial information regarding an object by outputting a very short light pulse to the object and measuring the time required for the light to be reflected by the object and returned.

The projection direction adjustment unit 410 may be configured to be capable of adjusting a position of an image projected by the projection device 100. In some aspects, the projection direction adjustment unit 410 may have a mechanism used for rotating or moving all or some of devices included in the device 400, and may adjust or move the position of a projected image by changing the direction or position of light projected from the projection device 100 using the mechanism.

In some aspects, the projection direction adjustment unit 410 may not be limited to the configuration illustrated in FIG. 3. In some instances, the projection direction adjustment unit 410 may be configured to be capable of reflecting light output from the projection device 100 by a movable mirror and/or changing the direction of the light through a special optical system. In some aspects, the movable mirror may be included in the device 400 or provided independently of the device 400. The projection direction adjustment unit 410 may be configured to be capable of moving the projection device 100 itself.

In some instances, the projection device 100 may change the size of a projected image in accordance with a projection surface by operating an internal lens and may adjust a focal position in accordance with a distance to the projection surface. When a line (an optical axis) connecting the center of the projection position of the projection surface with the center of the projection device 100 differs in direction from a line extended in a vertical direction of the projection surface, a projection distance varies within a projection range. Further, the projection device 100 may be realized by a specially designed optical system having a deep focal working distance for dealing with the above circumstances.

In other aspects, the projection device 100 may have a wide projection range, and the projection direction adjustment unit 410 may mask some of light emitted from the projection device 100 and may display an image on a desired position. Further, the projection device 100 may have a large projection angle, and the projection direction adjustment unit 410 may process an image signal so that the light is output only onto a required spot, and may pass the image data to the projection device 100.

The projection direction adjustment unit 410 may rotate or move the monitoring device 200 as well as the projection device 100. In some instances, in the case of the example illustrated in FIG. 3, the projection direction of the projection device 100 may be changed by the projection direction adjustment unit 410, and a monitoring direction (monitoring range) of the monitoring device 200 may be changed accordingly (that is, the monitoring range may be changed). Further, the projection direction adjustment unit 410 may include a high-precision rotation/position information obtaining device or the like in order to prevent the monitoring range of the monitoring device 200 from deviating from a predetermined region. The projection range of the projection device 100 and the monitoring range of the monitoring device 200 may be changed independently of each other.

The computer 1000 may change the orientation of the first image by performing image processing on the first image. Further, the projection device 100 may project the first image received from the computer 1000 without using the projection direction adjustment unit 410 to rotate the first image.

In some aspects, the device 400 may be installed while being fixed to a ceiling, a wall surface or the like. Further, the device 400 may be installed with the entirety thereof exposed from the ceiling or the wall surface, or the device 400 may be installed with the entirety or a part thereof buried inside the ceiling or the wall surface. In some instances, the projection device 100 may adjust the projection direction using the movable mirror, and the movable mirror may be installed on a ceiling or a wall surface, independently of the device 400.

Further, the projection device 100 and the monitoring device 200 may be included in the similar device 400 in abovementioned example. The projection device 100 and the monitoring device 200 may be installed independently of each other.

Further, a monitoring device used to detect the actual object and a monitoring device used to detect a user operation may be the same monitoring device or may be separately provided monitoring devices.

### Flow of Processing

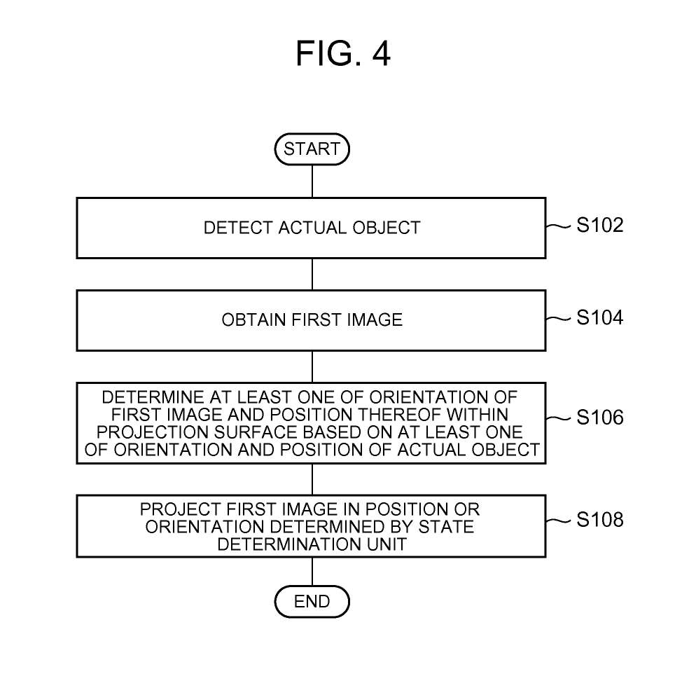

FIG. 4 is a flowchart depicting a flow of processing executed by the information processing system 2000 of the first exemplary embodiment. In Step S102, the actual object detection unit 2020 may detect an actual object. In Step S104, the information processing system 2000 may obtain a first image. In Step S106, the state determination unit 2080 may determine at least one of an orientation of the first image and a position thereof within the projection surface, based on at least one of an orientation and a position of the detected actual object. In Step S108, the projection unit 2060 may project the first image in the position or orientation determined by the state determination unit 2080.

According to this exemplary embodiment, at least one of the orientation of the image to be projected onto the projection surface and the position thereof within the projection surface may be determined based on at least one of the orientation and position of the detected actual object. The information processing system 2000 may be configured to be capable of detecting the projection surface, an object on the projection surface and/or an object around the projection surface, as the actual object. Thus, the orientation of the image to be projected and/or the position thereof within the projection surface may be determined based on the orientation or position of such an object. In some instances, as described later, the image may be projected in an orientation corresponding to an orientation of the face of the user, or the like. As a result, the first image may be projected in an easy-to-handle state for the user. Accordingly, the information processing system 2000 may be configured as a user-friendly system.

### First Example

In order to more easily understand the information processing system 2000 of this exemplary embodiment, an example of the information processing system 2000 of this exemplary embodiment will be described below. The usage environment and usage method of the information processing system 2000 that will be described hereinafter are illustrative examples, and they may not limit any other type of usage environments and usage methods of the information processing system 2000. It will be assumed that the hardware configuration of the information processing system 2000 of this example is that illustrated in FIG. 2.

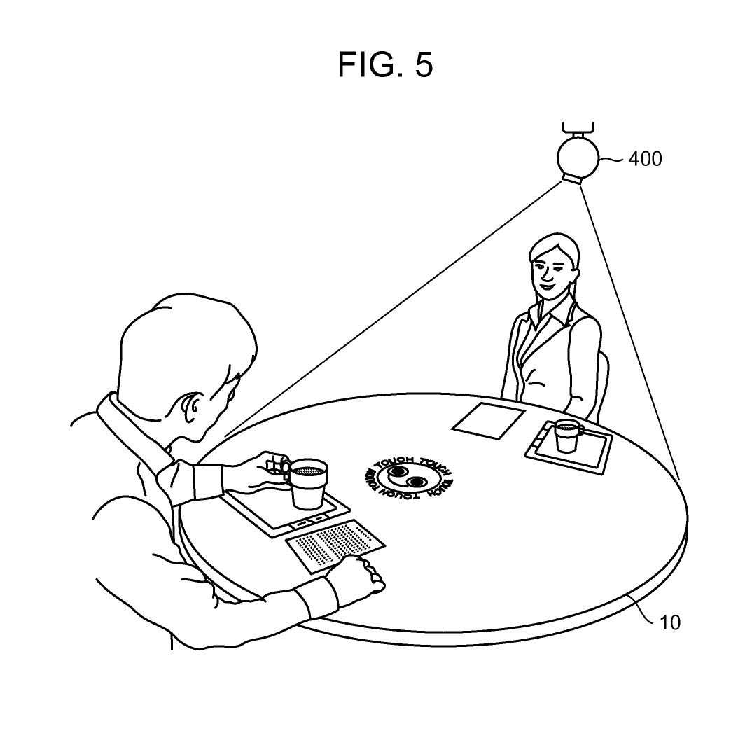

FIG. 5 is a diagram illustrating the usage environment of the information processing system 2000 of this example. The information processing system 2000 may be a system used in a coffee shop, restaurant or the like. The information processing system 2000 may realize digital signage by projecting images onto a table 10 from a device 400 installed on a ceiling. A user may have a meal or wait for a meal to be served while viewing contents projected onto the table 10 or the like. As is clear from FIG. 5, the table 10 may serve as a projection surface in this example. The device 400 may be installed in a location (e.g., a wall surface) other than the ceiling.

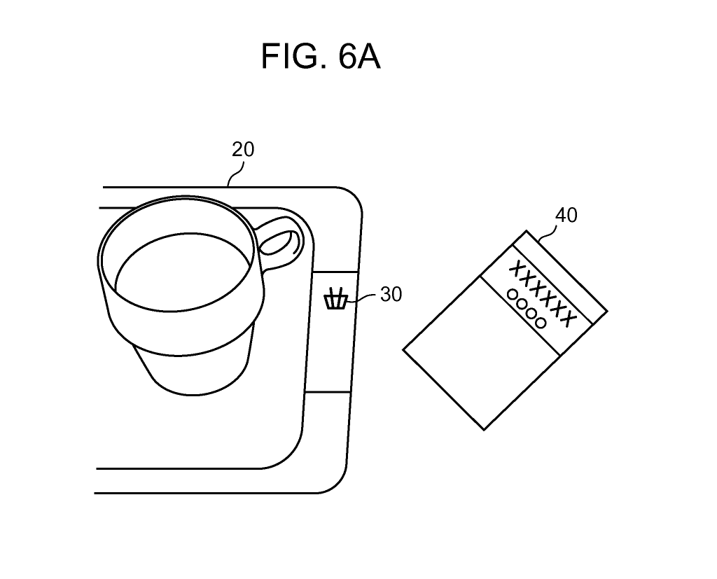

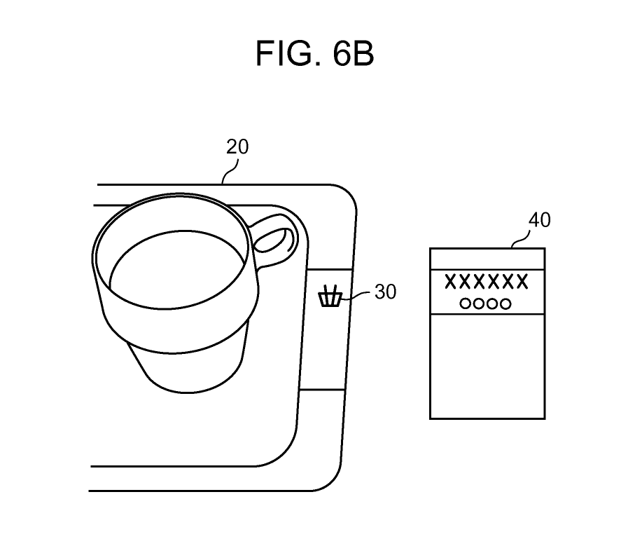

FIG. 6A and FIG. 6B are plan views illustrating a state of the table 10 around a user. In FIG. 6A and FIG. 6B, a content image 40 represents a front cover of an electronic book. In some aspects, contents represented by the content image 40 may be not only digital contents such as electronic books but may also be actual objects (analog contents). In other aspects, the content may be services.

An actual object in this example may be the user. In some instances, the information processing system 2000 may project the content image 40 in an orientation that makes it easy for the user to view, in accordance with the orientation of the user. FIG. 6A is a diagram illustrating a situation where the content image 40 is projected in an undesirable orientation. The content image 40 may be tilted to the right when viewed from the user. The orientation of the content image 40 in this state may be regarded as an orientation that makes it difficult for the user to view.

FIG. 6B is a diagram illustrating how the information processing system 2000 is projecting the content image 40 in an appropriate orientation corresponding to the orientation of the user. Since the content image 40 faces the front, the orientation of the content image 40 may coincide with the orientation that makes it easy for the user to view.

A method for projecting the content image 40 in accordance with the orientation of the user as illustrated in FIG. 6B, other methods for determining the position and orientation of the content image 40 by the information processing system 2000, and the like are described in detail later.

The information processing system 2000 of this exemplary embodiment may be described further in detail below.

### Method for Obtaining the First Image

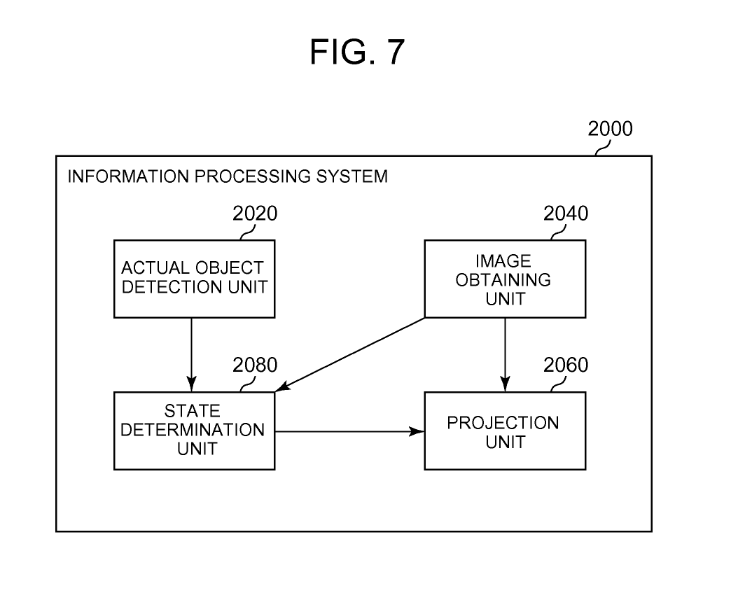

The information processing system 2000 may include a first image obtaining unit 2040 configured to obtain a first image, as illustrated in FIG. 7. The information processing system 2000 may include an actual object detection unit 2020, an image obtaining unit 2040, a projection unit 2060, and a state determination unit 2080. There are various methods in which the image obtaining unit 2040 obtains a first image. In some instances, the image obtaining unit 2040 may obtain a first image input from an external device. In other instances, the image obtaining unit 2040 may obtain a first image to be manually inputted. The image obtaining unit 2040 may access an external device to obtain a first image.

There may be plural first images for one content. In some instances, a content may be an electronic book, and an image of the front cover and images on individual pages for one electronic book may correspond to the plural first images. In other aspects, a content may be an actual object, and images obtained by photographing the actual object from various angles may correspond to the plural first images. The content represented by the first image may not be limited to a commodity but may be a service.

### Details of Projection Unit 2060

In some instances, the projection unit 2060 may include the projection device 100 such as a projector that projects images. The projection unit 2060 may obtain the first image obtained by the image obtaining unit 2040, and may project the obtained first image onto a projection surface.

There may be various projection surfaces onto which the projection unit 2060 projects images. In some instances, projection surfaces may include the table 10. In other instances, projection surfaces may include a wall, a floor and the like. In other instances, projection surfaces may include a human body (e.g., a palm). In other instances, projection surfaces may include a part of or the entirety of the actual object.

### Details of Actual Object Detection Unit 2020

The actual object detection unit 2020 may include the monitoring device 200. It will be assumed that “what is detected as an actual object” may be set in the actual object detection unit 2020. The actual object detection unit 2020 may determine whether or not an object that satisfies the set condition is included in the monitoring range of the monitoring device 200. If an object that satisfies the set condition is included, the object may be regarded as an actual object. The actual object may be a projection surface, an object on the projection surface, an object around the projection surface, or the like. In some instances, the projection surface may be the table 10 in FIG. 5. In other instances, the object on the projection surface may be a tray in FIG. 6A and FIG. 6B, or the like. In other instances, object around the projection surface may be the user in FIG. 5.

In some aspects, the monitoring device 200 may be an imaging device, and the actual object detection unit 2020 may detect the actual object by performing object recognition on an image generated by the monitoring device 200. As the object recognition technology, a known technology may be applicable.

In other aspects, the monitoring device 200 may include an imaging device compatible with light (such as infrared light and ultraviolet light) other than visible light, and an invisible image may be printed on the actual object. The actual object detection unit 2020 may detect the actual object by performing object recognition on an image including the invisible image printed on the actual object.

In some aspects, the actual object detection unit 2020 may be realized using a distance sensor. In a certain instance, the monitoring device 200 may be realized using a laser distance sensor. The actual object detection unit 2020 may detect the shape of an actual object and the shape change (distortion) of the actual object with time by measuring a variation of distance to the projection surface of the first image and/or to the vicinities of the projection surface using this laser-type distance sensor. As a processing for reading the shape and distortion, a known technology may be applicable.

### Method for Determining Direction of First Image

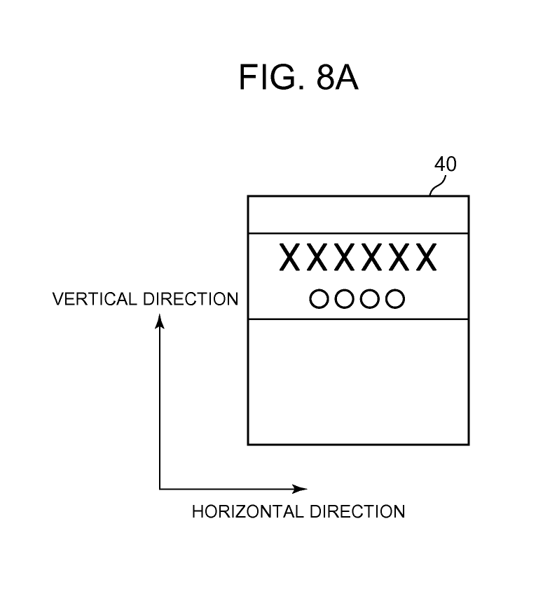

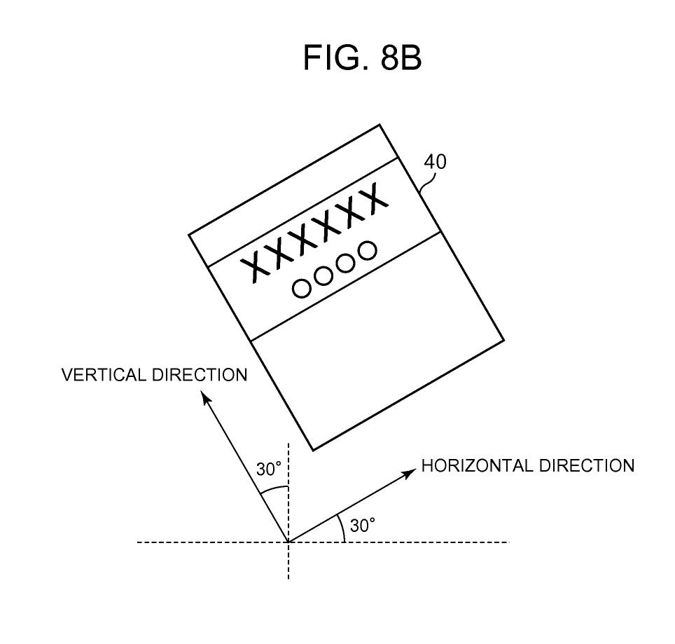

In some aspects, the orientation of the first image may be represented using a vertical direction or horizontal direction of the first image as an index. FIG. 8A and FIG. 8B are diagrams for illustrating the orientation of the content image 40. It will be assumed that the orientation of the content image 40 illustrated in FIG. 8A is the orientation in a reference state. In FIG. 8B, the orientation of the content image 40 is changed from the reference state. The orientation of the content image 40 in FIG. 8B may be represented as “the orientation in the horizontal direction may be changed by +30° from the reference state” or as “the orientation in the vertical direction may be changed by +30° from the reference state”. The orientation of the first image may be determined using an index other than the vertical direction or the horizontal direction.

### User's Face Direction

In some aspects, the state determination unit 2080 may identify the user's face orientation and may determine the orientation of the first image in accordance with the user's face orientation. In some instances, the actual object detection unit 2020 may detect the user's face, and the state determination unit 2080 may determine the face orientation from the detected face. The state determination unit 2080 may set the orientation of the first image in the vertical direction to be the same as that in which the user's face is directed.

### User's Eye Direction

In some aspects, the state determination unit 2080 may identify the user's eye orientation and determine the orientation of the first image in accordance with the user's eye direction. The user's eye direction may be identified from a positional relationship between white and black parts of the user's eye, or the like. In some instances, the actual object detection unit 2020 may detect positions of the white and black parts of the user's eye. For example, the state determination unit 2080 may set the orientation of the first image in the vertical direction to be the same as the user's eye direction.

### User's Body Direction

In some aspects, the state determination unit 2080 may identify the user's body direction and determine the orientation of the first image in accordance with the user's body direction. In some instances, the actual object detection unit 2020 may detect the body of the user, and the state determination unit 2080 may identify the body direction from the detected body. The state determination unit 2080 may determine the orientation of the first image in the horizontal direction, based on the user's body direction. In some instances, the body may be assumed to be oval, and the orientation of the first image in the horizontal direction may be set as a major axis direction of the body. Thus, the user facing the front may easily view the first image. In some aspects, the state determination unit 2080 may identify the major axis direction of the user's body, and set the orientation of the first image in the horizontal direction to be the same as the major axis direction.

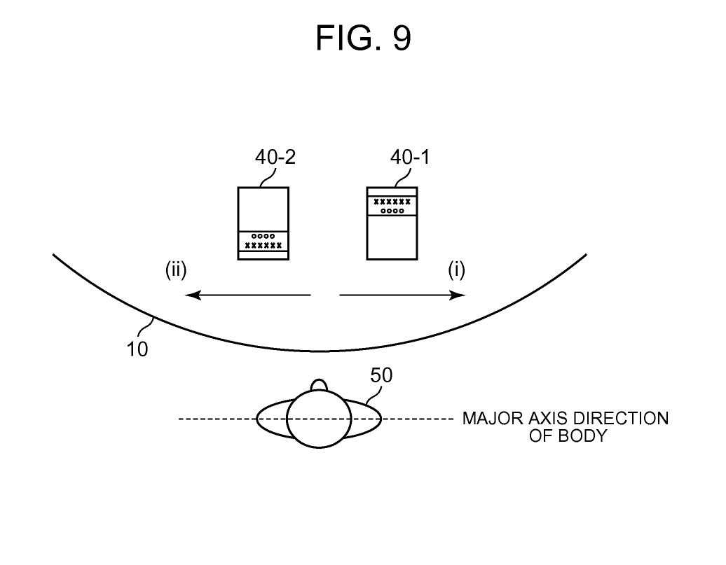

In some aspects, there may be two directions as the major axis direction of the user's body. Which one of the two directions is appropriate may be determined based on a positional relationship between the user and the table 10 (projection surface). FIG. 9 is a diagram illustrating a method for determining the direction of the content image 40 based on the major axis direction of the body of a user 50. In FIG. 9, considering the direction of the content image 40 based on only the major axis direction of the body of the user 50, two directions (i) and (ii) may be conceivable as the orientation of the content image 40 in the horizontal direction. In some aspects, the state determination unit 2080 may find out that (i) is appropriate from the positional relationship between the user and the projection surface, and project the content image onto the table 10 in an orientation indicated by the content image 40-1.

The state determination unit 2080 may use a method of “aligning the orientation of the first image in the vertical direction with a shortest diameter direction of the user's body”. In some aspects, two directions may be conceivable as the shortest diameter direction of the user's body. In other aspects, the state determination unit 2080 may determine an appropriate shortest diameter direction based on the positional relationship between the user and the projection surface.

In some instances, the calculation of the major axis direction of the user's body and the positional relationship between the user and the projection surface may be effective in a situation where it is difficult to calculate the user's eye orientation or face orientation. For example, the actual object detection unit 2020 may be realized by a low-resolution camera.

### User's Arm Direction

In other aspects, the state determination unit 2080 may identify the user's arm direction and determine the orientation of the first image in accordance with the user's arm direction. In some instances, the actual object detection unit 2020 may detect the arm of the user, and the state determination unit 2080 may identify the arm direction from the detected arm. The state determination unit 2080 may determine the orientation of the first image in the horizontal direction, based on the user's arm direction.

In some aspects, the user's two arms may be in different directions. In some instances, which one of the two arms is appropriate may be determined based on a positional relationship between the user and the table 10 (projection surface) or the like. As a first selection criterion, one of the two arms, which undergoes a large movement on the table 10, may be used. This is because the user may use either one of his/her arms (dominant arm in many cases) for operation. The both arms may move approximately in the same manner, and the arm on the side where there are fewer objects (e.g., trays 20 or the like) on the table 10 may be used as a second selection criterion. This is because unnecessary objects placed in a spot to be the projection surface may hinder the view. In some instances, the determination may be difficult even with the second selection criterion, and the right arm side may be used as a third determination criterion. This is because, statistically, the right arm is the dominant arm in most cases.

Using the user's arm direction as the criterion may be effective for contents with many inputs, such as a questionnaire form and a game, since the user's arm movement is minimized to facilitate the operation. In some instances, when the user's arm direction may be used as the criterion, when to determine the orientation of the first image may be important. Since the position and orientation of the user's arm change frequently during input, the orientation of the first image may be determined based on an average direction of the arm within a certain period of time or based on the direction of the arm at a certain moment, in accordance with the content.

### Use of Reference Point

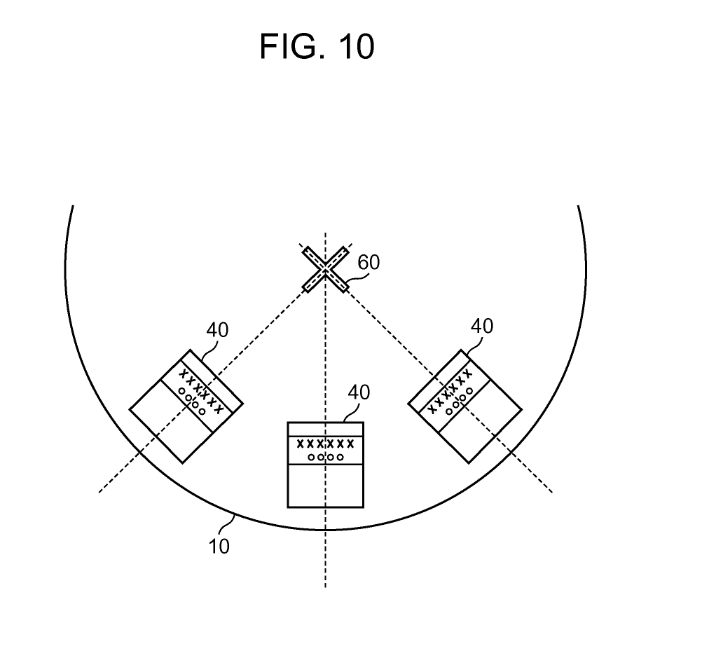

As another method for determining the orientation of the first image, there may be a method of pointing the first image to a reference point. FIG. 10 is a diagram illustrating a method for determining the orientation of the first image by using a reference point 70. Each of the dotted lines may indicate a line connecting the center of the content image 40 with the reference point 70. In the case of the example illustrated in FIG. 10, the state determination unit 2080 may determine the orientation of the content image 40 in the vertical direction to be capable of aligning the orientation with an extending direction of the line connecting the content image 40 with the reference point 70. As a result, in FIG. 10, each of the content images 40 may be projected such that the orientation thereof in the vertical direction is pointed to the reference point 70.

In some aspects, the reference point may be a mark provided beforehand on the projection surface. In other aspects, the state determination unit 2080 may use an object other than that provided beforehand on the projection surface, as the reference point. In some instances, the state determination unit 2080 may use the tray 20, a mark 30 or the like in FIG. 6A and FIG. 6B as the reference point. In other instances, the reference point may be an object around the projection surface. In other instances, the state determination unit 2080 may calculate a reference point in accordance with predetermined rules and use the calculated reference point. For example, the state determination unit 2080 may calculate a center point of the projection surface and use the center point as the reference point. Further, the state determination unit 2080 may use predetermined coordinates on the projection surface or its surrounding as the reference point.

Information indicating “what is used as the reference point” may be stored in a storage unit included in the information processing system 2000. In some instances, the state determination unit 2080 may use object recognition to specify the reference point, and a characteristic amount of an object to be used as the reference point, and the like may be stored in the storage unit. In other instances, the predetermined coordinates may be used as the reference point, and the coordinates may be stored in the storage unit.

### Direction of Operation Body

As another method for determining the orientation of the first image, there may be a method of aligning the orientation of the first image with the orientation of an operation body of a user. The operation body of the user may be the user's arm, hand or finger, a touch pen used by the user for operation, or the like. In some instances, the actual object detection unit 2020 may detect the operation body of the user. The state determination unit 2080 may identify an extending direction of the detected operation body, and determine the orientation of the first image based on the extending direction.

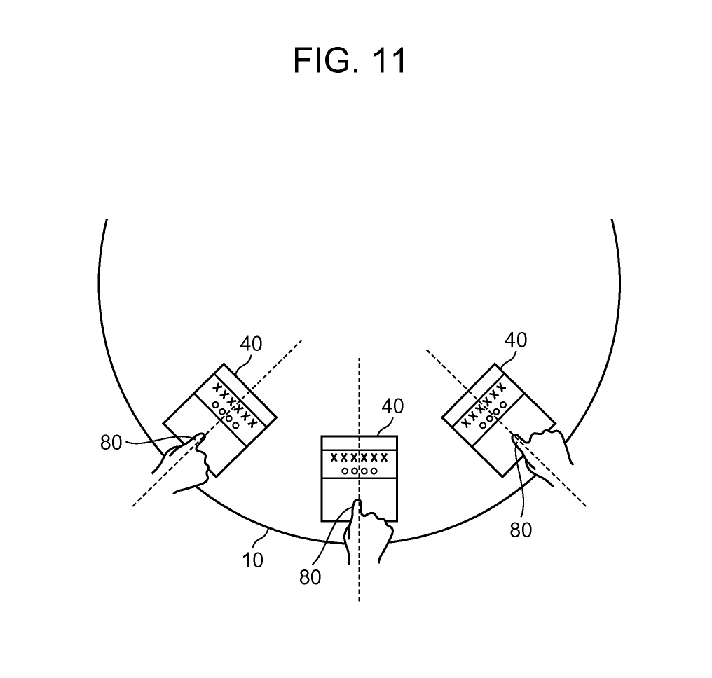

FIG. 11 is a diagram illustrating how the content image 40 is projected in accordance with an extending direction of a finger 80 of the user. Each of the dotted lines may indicate the extending direction of the finger 80. In the case of FIG. 11, the actual object detection unit 2020 may detect the finger 80, a user's hand including the finger 80, or the like as the actual object. The state determination unit 2080 may identify the extending direction (dotted line direction in FIG. 11) of the finger 80 from the finger 80 included in the actual object. The state determination unit 2080 may set the extending direction of the finger 80 as the direction of the content image 40 in the vertical direction.

Other examples of the method for determining the orientation of the first image are further described in exemplary embodiments to be described later.

### Determination of Position of First Image

In some aspects, the state determination unit 2080 may set a position within the projection surface and close to the actual object as a projection position of the first image. For example, the tray 20 or the mark 30 in FIG. 6A and FIG. 6B, the user 50 in FIG. 9, or the vicinity of the user's finger 80, hand or the like in FIG. 11 may be set as the projection position of the first image.

There may be various definitions for “the vicinity of the actual object”. In some instances, “the vicinity of the actual object” may be a position away from the actual object by a predetermined distance. The predetermined distance may be 0. In some instances, the first image may be projected in a position that comes in contact with the actual object or a position that overlaps with the actual object. Further, “the vicinity of the actual object” may be determined based on the size of the actual object. For example, when the size of the actual object is n, the state determination unit 2080 may project the first image in a position away from the actual object by n/x (n and x are positive real numbers). In some instances, the value x may be stored beforehand in the storage unit included in the information processing system 2000.

In other aspects, when the actual object is on the projection surface, the state determination unit 2080 may set a position on the actual object as the projection position of the first image. For example, it may be conceivable to project the first image on the tray 20 or the mark 30 in FIG. 6A and FIG. 6B or on the user's finger 80 or hand in FIG. 11.

Other examples of the method for determining the position of the first image are further described in the exemplary embodiments to be described later.

The state determination unit 2080 may use different actual objects to determine the position and orientation of the first image. For example, the vicinity of an object (e.g., the tray 20 in FIG. 6A and FIG. 6B) on the projection surface may be used as the position of the first image, and the orientation of the first image may be aligned with the user's face orientation.

In order to determine the orientation of the first image or the position thereof within the projection surface, the state determination unit 2080 may obtain information regarding the projected first image. For example, the state determination unit 2080 may obtain the first image itself, various attributes of the first image, or the like.

In some aspects, the state determination unit 2080 may obtain the information regarding the first image to be projected, from the image obtaining unit 2040 or the projection unit 2060. In other aspects, the state determination unit 2080 may obtain information (e.g., an ID of the first image) to specify the first image to be projected from the image obtaining unit 2040 or the projection unit 2060, and obtain other information regarding the specified first image from the outside of the information processing system 2000.

### Second Exemplary Embodiment

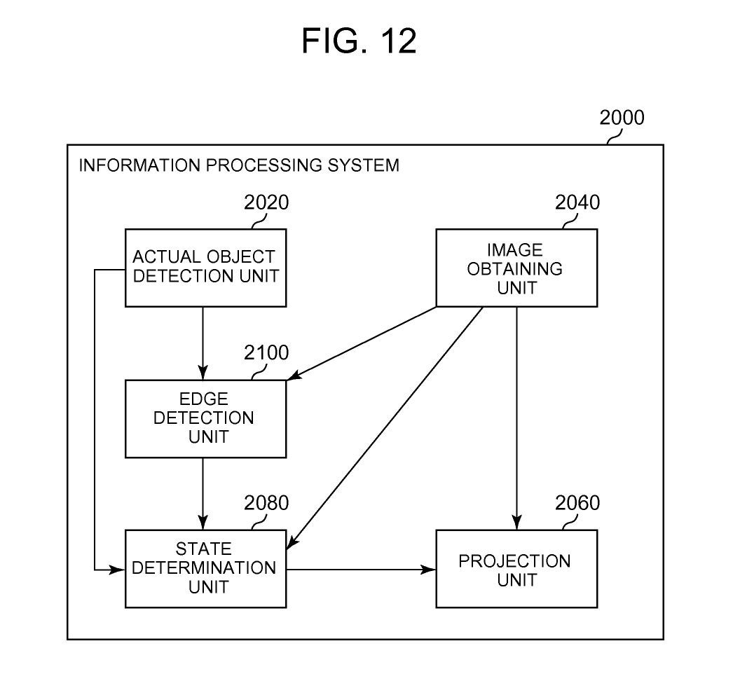

FIG. 12 is a block diagram illustrating an information processing system 2000 of second exemplary embodiment. In FIG. 12, arrows may indicate a flow of information. In FIG. 12, each of the blocks may indicate a functional unit configuration rather than a hardware unit configuration. The information processing system 2000 may include an actual object detection unit 2020, an image obtaining unit 2040, a projection unit 2060, a state determination unit 2080, and an edge detection unit 2100.

In the second exemplary embodiment, an actual object may be an object on a projection surface. The information processing system 2000 of the second exemplary embodiment may determine at least one of an orientation of a first image and a position thereof within the projection surface, based on at least one of an orientation and a position of an edge (e.g., an edge of a table) included in a circumference of the actual object. Thus, the information processing system 2000 of the second exemplary embodiment may include an edge detection unit 2100.

The edge detection unit 2100 may detect the edge included in the circumference of the actual object. A state determination unit 2080 of the second exemplary embodiment may determine at least one of the orientation of the first image and the position thereof within the projection surface, based on at least one of the orientation and position of the detected edge.

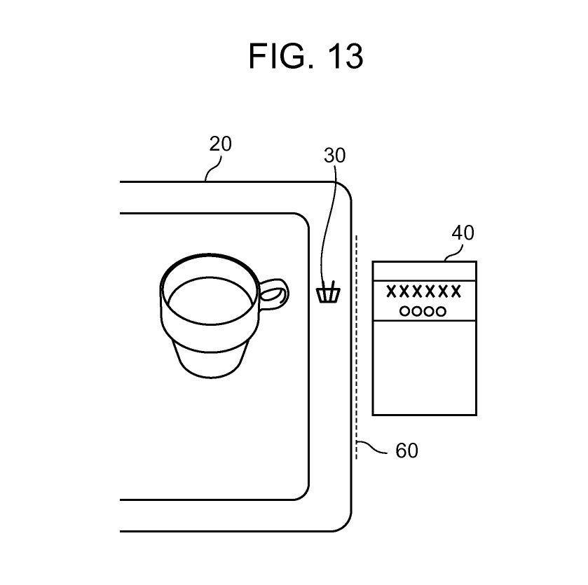

FIG. 13 is a diagram illustrating an edge detected by the edge detection unit 2100. In FIG. 13, the actual object may be a tray 20. In some aspects, the edge detection unit 2100 may detect an edge 60 that is an edge included in a circumference of the tray 20. The state determination unit 2080 may determine an orientation of a content image 40 in accordance with an extending direction of the edge 60. The state determination unit 2080 may set the vicinity of the edge 60 as a projection position of the content image 40. “The vicinity of the edge 60” may be defined in the same manner as “the vicinity of the actual object” described in the first exemplary embodiment.

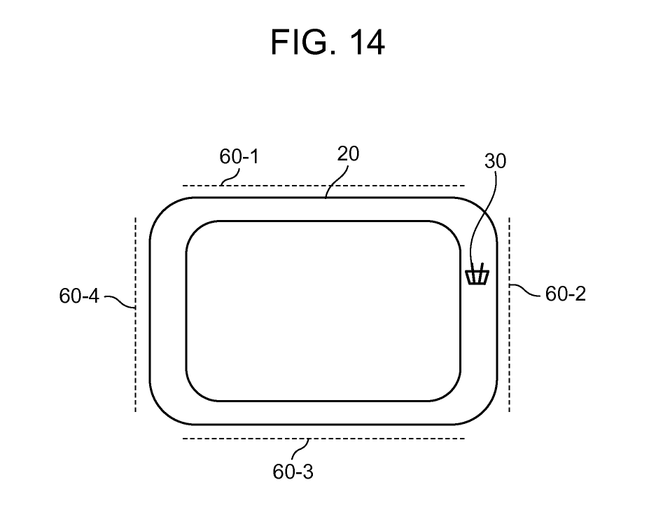

The actual object may generally have more than one edge. In some aspects, the state determination unit 2080 may specify an edge to be used to determine the orientation or position of the first image, in accordance with some kind of criteria. In some instances, as one method, a mark or the like to be a reference is provided beforehand on the actual object. In some instances, the state determination unit 2080 may use an edge near the mark among edges included in the actual object. FIG. 14 is a diagram illustrating each of the edges of the tray 20 with a mark 30. In FIG. 14, the tray 20 may have four edges 60-1 to 60-4. The state determination unit 2080 may use the edge 60-2 that is the edge near the mark 30, among the four edges.

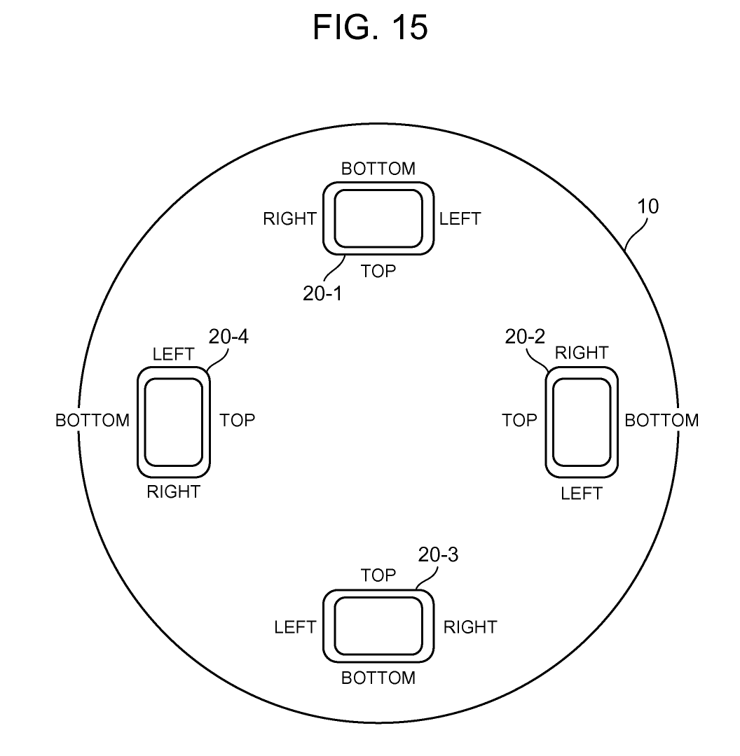

In some aspects, the information processing system 2000 may determine beforehand which edge is to be used, without providing a mark or the like on the actual object. For example, when it is determined that the tray 20 is to be used as the actual object, “use the right-hand edge of the tray 20” or the like may be determined beforehand. Which edge of the tray 20 is the right-hand edge may be identified based on where on the projection surface the tray 20 is placed. FIG. 15 is a diagram illustrating relationships between positions of the trays 20 and the respective edges on the table 10. In FIG. 15, the position of each of the trays 20-1 to 20-4 may determine which one of upper, lower, left and right edges each of the edges is, for each of the trays 20. A method of “setting an edge closest to the center of the table 10, among the edges of the tray 20, as the upper edge” may identify which edge each edge of the tray 20 is.

The “edge” in this exemplary embodiment may mean a part of the circumference (one of the edges) of the actual object, and may not be limited to a line segment that terminates at a vertex of the actual object. For example, the actual object may be a spherical object or a disk-shaped object, and an arc that is a part of the circumference may serve as the edge. In some aspects, the edge may be a curved line as described above, and the state determination unit 2080 may use a tangential direction to the edge as the orientation of the edge.

In some instances, the actual object may not have a vertex or a corner that can be regarded as a vertex, such as the spherical body or the disk-shaped object, and the edge detection unit 2100 may use a predetermined method to divide the circumference of the actual object into edges, thereby detecting the edge. There may be various methods to divide the circumference into edges. In some instances, the edge detection unit 2100 may divide the circumference into edges, each having a predetermined size. In other instances, there may be a method of “dividing the circumference into 20-cm edges”. Alternatively or additionally, the edge detection unit 2100 may divide the circumference into a predetermined number of edges. For example, there may be a method of “dividing the circumference into five equal parts”.

In some aspects, using such a method of dividing the circumference into edges, each of the edges of the circumference having a vertex or a corner that can be regarded as a vertex may be subdivided into edges, as illustrated in FIG. 14. In FIG. 14, it may be conceivable to divide each of the four edges into quarters, thereby obtaining sixteen edges.

### Flow of Processing

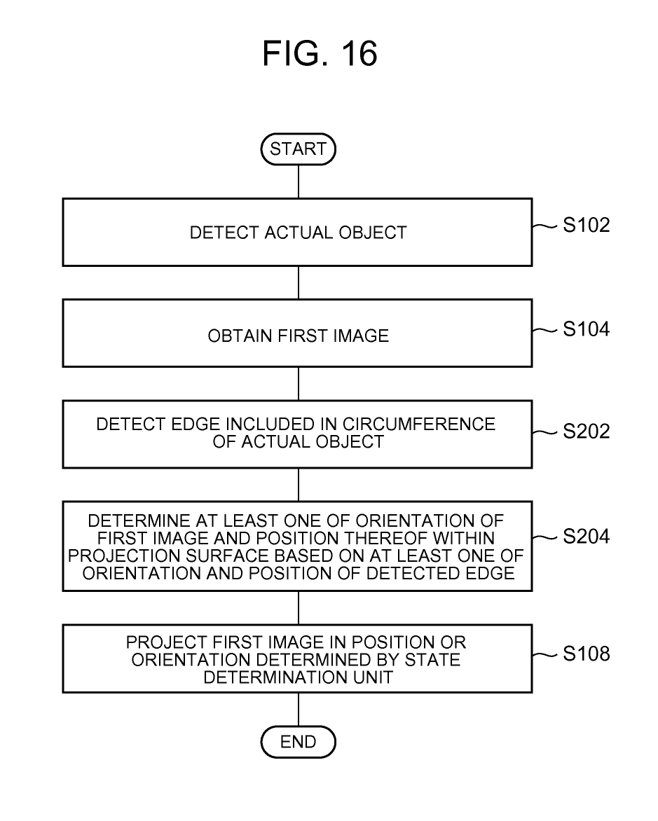

FIG. 16 is a flowchart depicting a flow of processing executed by the information processing system 2000 of the second exemplary embodiment. By way of example, the information processing system 2000 may be configured to perform the exemplary processes of FIG. 4 to detect an actual object by the actual object detection unit 2020 (e.g., step S102 of FIG. 4), to obtain a first image (e.g., step S104 of FIG. 4), and to determine at least one of an orientation of the first image and a position thereof within the projection surface, based on at least one of an orientation and a position of the detected actual object (e.g., step S106 of FIG. 4).

In Step S202, the edge detection unit 2100 may detect an edge included in the circumference of the actual object. In Step S204, the state determination unit 2080 may determine at least one of an orientation of the first image and a position thereof within the projection surface, based on at least one of an orientation and a position of the detected edge. By way of example, the information processing system 2000 may be configured to perform the exemplary processes of FIG. 4 to project the first image in the position or orientation determined by the state determination unit 2080 (e.g., step S108 of FIG. 4).

According to this exemplary embodiment, at least one of the orientation of the first image and the position thereof within the projection surface may be determined based on at least one of the orientation and position of the edge included in the circumference of the actual object on the projection surface. There may be a high possibility that the actual object on the projection surface is placed in an easy-to-handle state for the user. For example, a tray, portable terminal, pens and pencils or the like placed on a table or the like by the user may be likely to be placed in an easy-to-handle orientation or position for the user. In other instances, the actual object (e.g., a menu or the like in a restaurant) may be placed on a table or the like beforehand for the user, and the actual object may be generally placed in an easy-to-handle orientation or position for the user. Thus, the edge included in the circumference of the actual object placed on the projection surface may be regarded as indicating the easy-to-view orientation or position for the user. Therefore, according to this exemplary embodiment, there may be a high probability that the first image is projected in the easy-to-view orientation or position for the user. In other aspects, the processing of calculating the orientation of the edge may be simpler than processing of detecting the face orientation, eye orientation or the like of the user. Thus, computation time and computer resources required to determine the orientation or position of the first image may be reduced. As a result, the projection processing of the first image by the information processing system 2000 may be speeded up.

### Second Example

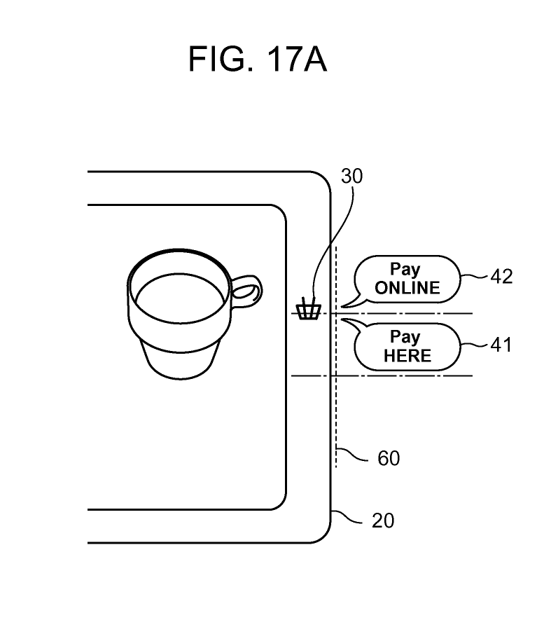

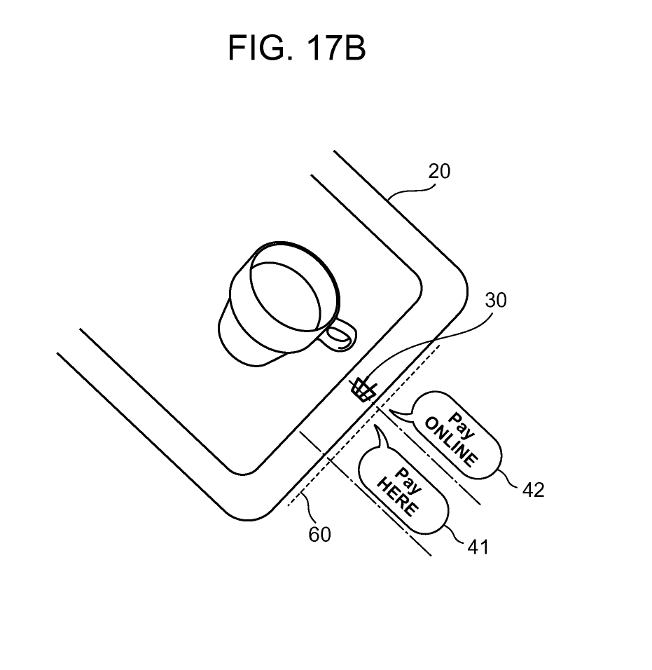

In order to more easily understand the information processing system 2000 of the second exemplary embodiment, a concrete usage example of the information processing system 2000 of the second exemplary embodiment will be described as a second example. The assumed environment of this example may be similar to the assumed environment of the first example. FIG. 17A and FIG. 17B are diagrams illustrating a situation on a table in the second example. In some instances, a mark 30 provided on a tray 20 may be a mark representing a shopping cart. The information processing system 2000 may provide a function capable of putting a content represented by one of the content images 41 and 42 into a user's shopping cart by dragging the one of the content images 41 and 42 to the mark 30.

The user may choose between a cash register and online to pay for the content put into the shopping cart. For this choosing, the information processing system 2000 may display a content image 41 (Pay HERE) to select “payment at cash register” and a content image 42 (Pay ONLINE) that is an image to select “online payment”. The “content” in the content images 41 and 42 may mean a payment service provided by the information processing system 2000.

As illustrated in FIG. 17A and FIG. 17B, the two images may have a balloon shape. The state determination unit 2080 may determine display positions of the content images 41 and 42 so that each of the content images 41 and 42 looks as if the balloon pops out of the mark 30. Thus, the state determination unit 2080 may use the mark 30 as the actual object to determine projection positions of the content images 41 and 42.

In some aspects, the state determination unit 2080 may display the content images 41 and 42 so that the images follow an edge of the tray 20. Therefore, the edge detection unit 2100 may detect an edge 60 that is one of the edges of the tray 20 and is one around the mark 30. The state determination unit 2080 may determine the orientation of the content images 41 and 42 in the vertical direction based on an extending direction of the edge 60.

The edge detection unit 2100 may determine the orientation of the content images 41 and 42 using a method of “aligning the orientation of the content images 41 and 42 in the horizontal direction with the direction perpendicular to the edge 60”.

For example, when the orientation of the tray 20 is changed, the information processing system 2000 may change the positions or orientation of the content images 41 and 42 to follow the change. It will be assumed that the orientation and position of the tray 20 originally placed as illustrated in FIG. 17A are changed to those illustrated in FIG. 17B. In some instances, the information processing system 2000 may change the positions and orientations of the content images 41 and 42 in accordance with the changed position and orientation of the tray 20 as illustrated in FIG. 17B.

### Third Exemplary Embodiment

An information processing system 2000 of a third exemplary embodiment may have a configuration illustrated in FIG. 12 as in the case of the second exemplary embodiment.

In the third exemplary embodiment, an actual object to be detected by an actual object detection unit 2020 may be a user close to a projection surface. An edge detection unit 2100 of the third exemplary embodiment may detect an edge which is included in a circumference of the projection surface and is close to the user. A state determination unit 2080 of the third exemplary embodiment may determine at least one of an orientation of a first image and a position thereof within the projection surface, based on at least one of an orientation and a position of the detected edge.

The actual object detection unit 2020 of the third exemplary embodiment may detect a user close to the projection surface. The edge detection unit 2100 of the third exemplary embodiment may detect an edge which is included in a circumference of the projection surface and is close to the user detected by the actual object detection unit 2020.

In some aspects, there may be many users around the projection surface and the first image is shared by all the users. For example, the edge detection unit 2100 may detect an edge close to the position of the center of gravity among the positions of the users. For example, the edge detection unit 2100 may determine a user to be a reference among the users, and detect an edge close to the user. It will be assumed that the actual object detection unit 2020 detects not only a user but also an object around the user, such as a chair. In some instances, the edge detection unit 2100 may detect a user sitting in a chair and regards the user sitting in the chair as a reference user. In other aspects, an object may be placed on the projection surface (e.g., a tray 20 on a table 10), and the edge detection unit 2100 may set a user closest to the object placed on the projection surface as the reference user.

### Determination of Direction of First Image

In some aspects, the edge detected by the edge detection unit 2100 may be a straight line, and the state determination unit 2080 may determine the orientation of the first image so that the orientation of the first image in the horizontal direction is aligned with the extending direction of the detected edge. In other aspects, the edge detected by the edge detection unit 2100 may be a curved line, and the state determination unit 2080 may find out a tangent line to the detected edge and determine the orientation of the first image so that the orientation of the first image in the horizontal direction is aligned with the direction of the tangent line.

### Determination of Position of First Image

The state determination unit 2080 may set the vicinity of the edge detected by the edge detection unit 2100 as a projection position of the first image. “The vicinity of the edge” may be defined in the similar manner as “the vicinity of the actual object” described in the first exemplary embodiment.

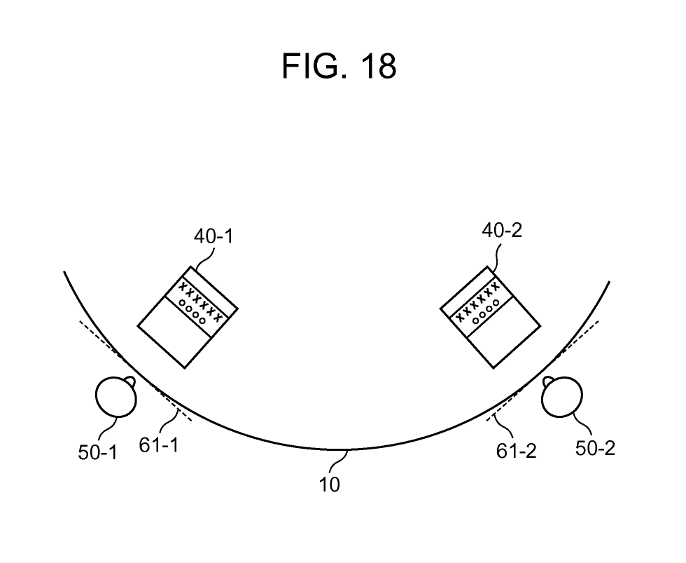

FIG. 18 is a diagram illustrating processing performed by the state determination unit 2080 of the third exemplary embodiment. The edge detection unit 2100 may detect an edge close to a user 50-1 among the edges included in the circumference of the table 10 that is the projection surface, and calculate a tangent line 61-1 thereto. The state determination unit 2080 may determine the orientation and position of a content image 40-1 to be presented to the user 50, based on the tangent line 61-1. The state determination unit 2080 may set the vicinity of the user 50-1 as the projection position of the content image 40-1. In other aspects, the state determination unit 2080 may determine the orientation of the content image 40-1 so that the horizontal direction of the content image 40-1 is aligned with the extending direction of the tangent line 61-1. As a result, the orientation and position of the content image 40-1 may be as illustrated in FIG. 18. The information processing system 2000 may perform the similar processing to project a content image 40-2 to be presented to a user 50-2.

According to this exemplary embodiment, at least one of the orientation of the first image and the position thereof within the projection surface may be determined based on at least one of the orientation and position of the edge included in the circumference of the projection surface and close to the user. An image to be projected by the information processing system 2000 may be likely to be viewed by the user close to the projection surface. In some aspects, the user may be likely to view the projection surface in the orientation corresponding to the edge included in the circumference of the projection surface, such as an edge of a table. Therefore, according to this exemplary embodiment, the image may be projected in an easy-to-view state for the user. The processing of calculating the orientation of the edge may be simpler than processing of detecting the face orientation, eye orientation or the like of the user. Thus, computation time and computer resources required to determine the orientation or position of the first image may be reduced. As a result, the projection processing of the first image by the information processing system 2000 may be speeded up.

### Fourth Exemplary Embodiment

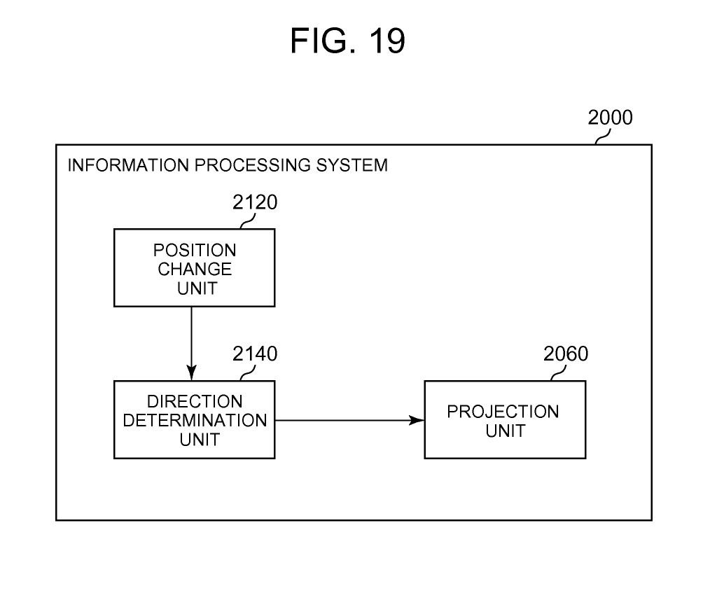

FIG. 19 is a block diagram illustrating an information processing system 2000 of a fourth exemplary embodiment. In FIG. 19, solid arrows may indicate a flow of information, while dotted arrows may indicate a flow of energy. In FIG. 19, each of the blocks may indicate a functional unit configuration rather than a hardware unit configuration.

The information processing system 2000 of the fourth exemplary embodiment may include a projection unit 2060, a position change unit 2120, and a direction determination unit 2140.

The position change unit 2120 may detect a user operation and change the position of the first image on the projection surface in accordance with the detected user operation. The direction determination unit 2140 may determine the orientation of the first image to be projected, based on a movement direction of the first image. The projection unit 2060 may change the orientation of the first image in accordance with the orientation determined by the direction determination unit 2140. The projection unit 2060 may project the first image in the position changed by the position change unit 2120.

The information processing system 2000 of the fourth exemplary embodiment may include the image obtaining unit 2040 configured to obtain the first image, as in the case of the information processing system 2000 of the first exemplary embodiment.

### Details of Position Change Unit 2120

There may be various user operations to be detected by the position change unit 2120. The user operations to be detected by the position change unit 2120 may include an operation of the user dragging the first image with an operation body. The operation to be detected by the position change unit 2120 may be an operation of pressing or punching, with the operation body, a spot on the projection surface where the first image is not projected. In some aspects, the position change unit 2120 may change the position of the first image so that the first image is moved toward the spot pressed with the operation body. In other aspects, the distance for which the first image is moved in one user operation may be a predetermined distance or may vary in accordance with conditions. The conditions for varying the distance may include the number of operation bodies (e.g., fingers) used for the operation, the magnitude of the movement of the operation bodies, and the like.

The user operation performed using the operation body as described above may be detected using the monitoring device. As a processing for detecting a user operation using the monitoring device, a known technology may be applicable. In some aspects, the position change unit 2120 may detect a user operation using an imaging device, and the user operation may be detected by analyzing movement of the operation body presented in a captured image.

In other aspects, the user operation to be detected by the position change unit 2120 may be an operation of moving the first image using an external input device such as a wireless mouse.

There may be a time lag between timing of detecting the user operation by the position change unit 2120 and timing of changing a projection state (position or direction) of the first image by the projection unit 2060. When the time lag is small, the first image may be projected so as to quickly follow the user operation. In other aspects, when the time lag is large, the first image may be projected so as to slowly follow the user operation.

### Details of Direction Determination Unit 2140

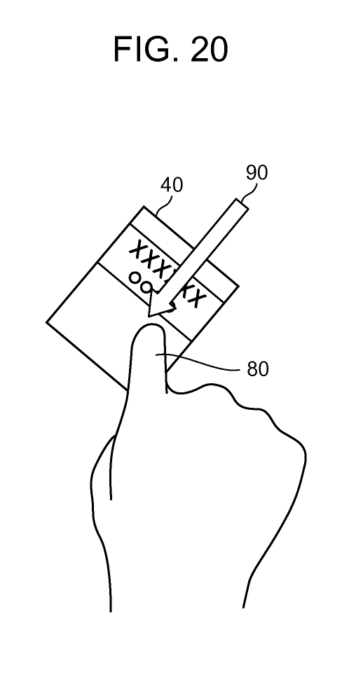

The direction determination unit 2140 may determine the orientation of the first image to be projected, based on the movement direction of the first image. FIG. 20 is a diagram illustrating processing executed by the direction determination unit 2140. The arrow 90 may indicate a direction in which a content image 40 is moved by a finger 80. In some aspects, the direction determination unit 2140 may determine the orientation of the content image 40 so that the orientation of the content image 40 in the vertical or horizontal direction is aligned with the movement direction of the content image 40.

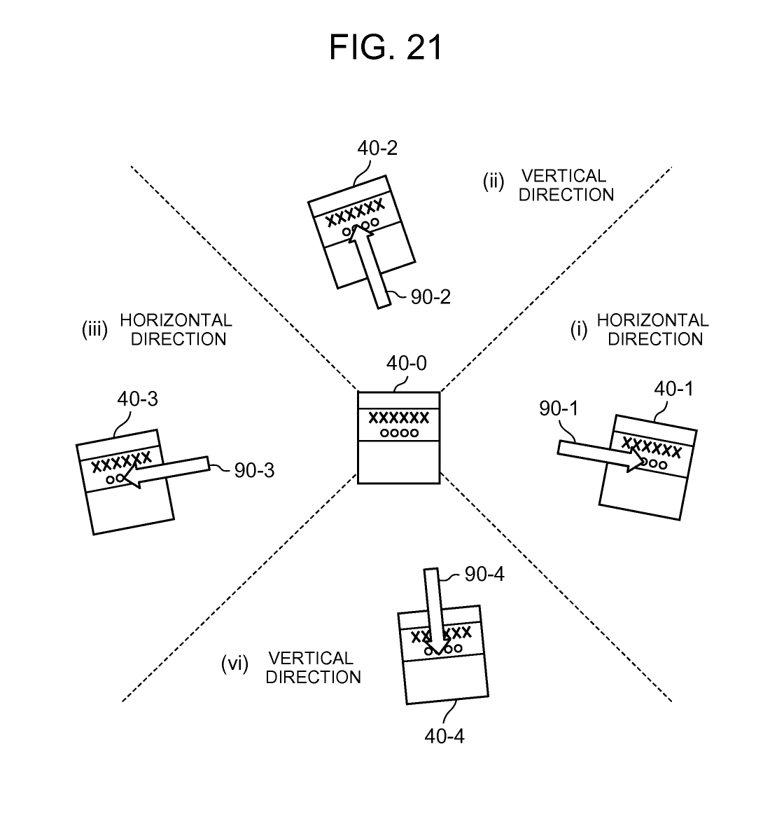

Which one of the horizontal direction and the vertical direction of the content image 40 is aligned with the movement direction of the content image 40 may be determined beforehand or may be selected in accordance with circumstances. A method for selecting in accordance with circumstances is described with reference to FIG. 21. FIG. 21 is a diagram illustrating a relationship between a movement direction of the content image 40 and a direction of the content image 40 in the movement direction. A content image 40-0 may be an initial state when the content image 40 is projected onto the projection surface. In some aspects, the direction determination unit 2140 may divide the movement direction of the content image 40 into four groups, (i) −45° to +45°, (ii) +45° to +135°, (iii) +135° to +225°, and (vi) +225° to +315°, with the horizontal direction of the content image 40 in the initial state as +0°. In some aspects, the movement direction of the content image 40 may be included in the groups (i) and (iii), and the direction determination unit 2140 may align the orientation of the content image in the horizontal direction with the movement direction of the content image 40. In other aspects, the movement direction of the content image 40 may be included in the groups (ii) and (vi), and the direction determination unit 2140 may align the orientation of the content image in the vertical direction with the movement direction of the content image 40.

The orientation of the content image 40-0 in the initial state may be determined by any of the methods described in the first exemplary embodiment to the third exemplary embodiment. Thus, the orientation of the content image 40-0 may be considered to be an orientation that makes it easy for the user to view. The orientation of the content image 40 to be moved may be set to the easy-to-view orientation for the user by determining the orientation of the content image 40 based on the grouping with reference to FIG. 21 in such a situation. The respective angles used for the grouping described with reference to FIG. 21 may not be limited to those in the above example. The number of the groups may not have to be four.

In order to determine the orientation of the first image, the direction determination unit 2140 may obtain information about the first image using the similar method as that used by the state determination unit 2080 in the first exemplary embodiment.

### Calculation of Movement Direction

In some aspects, the direction determination unit 2140 may calculate the movement direction of the first image based on a change in the projection position of the first image. In some instances, the direction determination unit 2140 may calculate the movement direction of the first image based on the direction in which the first image has been moved, or based on a direction in which the first image is to be moved. In some aspects, the direction determination unit 2140 may use a combination of “the current projection position of the first image and the previous projection position of the first image”, and the direction determination unit 2140 may calculate the direction in which the first image has been moved. In other aspects, the direction determination unit 2140 may use a combination of “a next projection position of the first image and the current projection position of the first image”, and the direction determination unit 2140 may calculate the direction in which the first image is to be moved.

There may be various frequencies of calculating the movement direction of the first image by the direction determination unit 2140. In some aspects, the direction determination unit 2140 may calculate the movement direction of the first image at predetermined time intervals, such as for each second. In other aspects, the direction determination unit 2140 may intermittently calculate the movement direction of the first image.

There may be various frequencies of changing the movement direction of the first image by the direction determination unit 2140. In some aspects, the direction determination unit 2140 may change the orientation of the first image whenever the direction determination unit 2140 calculates the orientation of the first image, in accordance with the calculated orientation. In other aspects, the direction determination unit 2140 may change the orientation of the first image when the movement direction of the first image satisfies predetermined conditions. In some instances, the direction determination unit 2140 may store the movement orientation of the first image calculated in last time, and change the orientation of the first image when the movement direction calculated in this time is different from the stored movement direction by a predetermined angle or more.

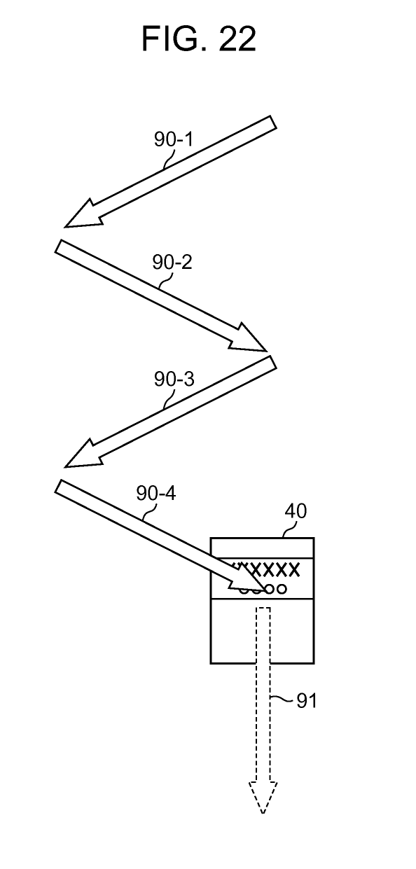

In other aspects, the direction determination unit 2140 may calculate a time-averaged movement speed of the first image and determine the orientation of the first image to be projected, based on a direction indicated by the calculated average movement speed. With reference to FIG. 22, description is given of processing performed by the direction determination unit 2140 in this case. FIG. 22 is a diagram illustrating a method for determining the orientation of the content image 40 using the average movement speed. The arrows 90-1 to 90-4 in FIG. 22 may indicate speeds of the first image during periods p1 to p4. In some aspects, the direction determination unit 2140 may calculate the average movement speed of the four movement speeds. This average movement speed may be indicated by the arrow 91. In some aspects, the direction determination unit 2140 may change the orientation of the first image in accordance with the direction of the arrow 91 that is the average movement speed after the elapse of the period p4 without changing the orientation of the first image during p1 to p4. The direction determination unit 2140 may calculate the average speed at arbitrary time intervals.

The method using the average movement speed may be effective when the movement direction of the first image is changed frequently within a short period of time, for example. In some aspects, when the content image 40 is moved zigzag as illustrated in FIG. 22 within a short period of time, the orientation of the content image 40 may become unstable if the orientation of the content image 40 is changed every time the movement direction changes. This may make the content image 40 difficult for the user to view. In other aspects, the orientation of the content image 40 may be stabilized by changing the orientation of the content image 40 at certain time intervals using the average movement speed, resulting in an easy-to-view image for the user.

### Hardware Configuration

The information processing system 2000 of the fourth exemplary embodiment may have the hardware configuration illustrated in FIG. 2, as in the case of the hardware configuration of the information processing system 2000 of the first exemplary embodiment, for example. A program stored in a storage 1080 may be different from that in the first exemplary embodiment. The storage 1080 of the fourth exemplary embodiment may include a projection module 1260, a position change module 1320 and a direction determination module 1340.

### Flow of Processing

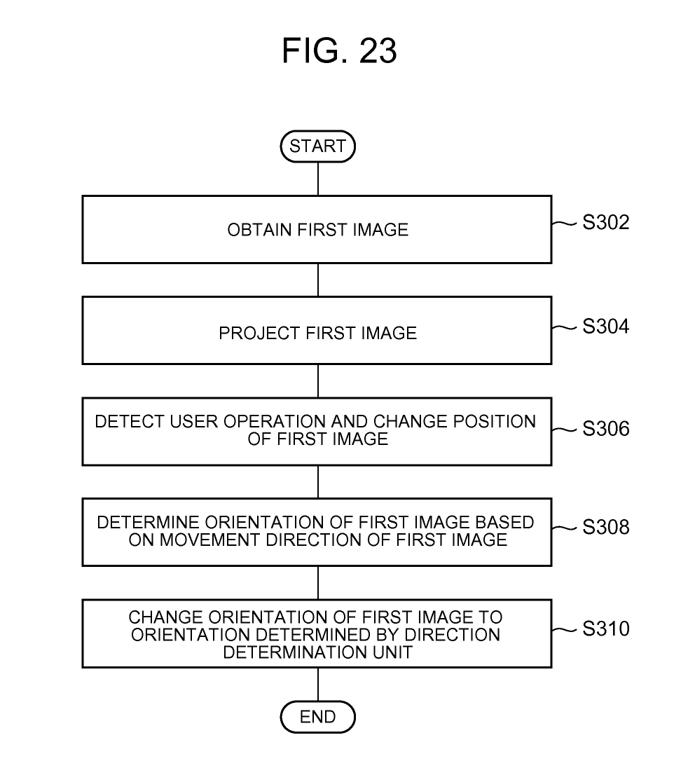

FIG. 23 is a flowchart depicting a flow of processing executed by the information processing system 2000 of the fourth exemplary embodiment. In Step S302, the image obtaining unit 2040 may obtain a first image. In Step S304, the projection unit 2060 may project the first image. In Step S306, the position change unit 2120 may detect a user operation and change a position of the first image based on the detected user operation. In Step S308, the direction determination unit 2140 may determine an orientation of the first image based on a movement direction of the first image. In Step S310, the projection unit 2060 may change the orientation of the projected first image to the orientation determined by the direction determination unit 2140.

According to this exemplary embodiment, the information processing system 2000 may change the orientation of the projected first image based on the movement direction of the first image. Accordingly, the information processing system 2000 may determine the orientation of the projected first image so as to follow the movement direction of the first image. Thus, the information processing system 2000 may display the first image in an orientation easy for the user to view.

Although the exemplary embodiments of the present disclosure are described above with reference to the drawings, these exemplary embodiments are just examples of the present disclosure, and various configurations other than those described above may be adopted.

The present disclosure is not limited to the above mentioned exemplary embodiments. It can be described as follows, but it may not be limited to this.

### Supplementary Note 1:

An information processing system including:

a memory storing instructions; and

at least one processor configured to process the instructions to:

detect an actual object;

determine at least one of an orientation and a position of a first image within a projection surface, based on at least one of an orientation and a position of the actual object;

project the first image onto the projection surface in at least one of the determined position and the determined orientation.

### Supplementary Note 2

The information processing system according to supplementary note 1, wherein the at least one processor is configured to process the instructions to:

detect an edge included in a circumference of the actual object; and

determine at least one of the orientation and position of the first image within the projection surface, based on at least one of an orientation and a position of the detected edge.

### Supplementary Note 3

The information processing system according to supplementary note 1, wherein

the actual object is a user, and

wherein the at least one processor is configured to process the instructions to:

detect an edge which is included in a circumference of the projection surface; and determine at least one of the orientation and position of the first image within the projection surface, based on at least one of an orientation and a position of the detected edge.

### Supplementary Note 4

The information processing system according to supplementary note 1, wherein the at least one processor is configured to process the instructions to determine the orientation of the first image based on an extending direction of a line connecting the position of the projected first image and a reference point on the projection surface.

### Supplementary Note 5

The information processing system according to supplementary note 1, wherein

the actual object is an operation body of a user, and

wherein the at least one processor is configured to process the instructions to determine the orientation of the first image, based on an extending direction of the operation body.

### Supplementary Note 6

An information processing system including:

a memory storing instructions; and

at least one processor configured to process the instructions to:

project a first image onto a projection surface;

detect a user operation;

determine an orientation of the first image, based on a movement direction of a position on which the first image is projected.

### Supplementary Note 7

The information processing system according to supplementary note 6, wherein the at least one processor is configured to process the instructions to:

calculate a time-averaged movement speed of the first image; and

determine the orientation of the first image, based on a direction indicated by the calculated average movement speed.

### Supplementary Note 8

An information processing method including:

detecting an actual object;

determining at least one of an orientation and a position of a first image within a projection surface, based on at least one of an orientation and a position of the actual object; and

projecting the first image onto the projection surface in in at least one of the determined position and determined orientation.

### Supplementary Note 9

The information processing method according to supplementary note 8, including:

detecting an edge included in a circumference of the actual object; and

determining at least one of the orientation and the position of the first image within the projection surface, based on at least one of an orientation and a position of the detected edge.

### Supplementary Note 10

The information processing method according to supplementary note 8, wherein the actual object is a user, and including:

detecting an edge which is included in a circumference of the projection surface; and

determining at least one of the orientation and the position of the first image within the projection surface, based on at least one of an orientation and a position of the detected edge.

### Supplementary Note 11

The information processing method according to claim 8, including determining the orientation of the first image based on an extending direction of a line connecting the position of the projected first image and a reference point on the projection surface.

### Supplementary Note 12

The information processing method according to supplementary note 8, wherein

the actual object is an operation body of a user, and the method further comprising determining the orientation of the first image to be projected, based on an extending direction of the operation body.

### Supplementary Note 13

An information processing method including:

projecting a first image onto a projection surface;

detecting a user operation;

determining an orientation of the first image, based on a movement direction of a position on which the first image is projected.

### Supplementary Note 14

The information processing method according to supplementary note 13, including:

calculating a time-averaged movement speed of the first image; and

determining the orientation of the first image, based on a direction indicated by the calculated average movement speed.

### Supplementary Note 15

A non-transitory computer-readable storage medium storing instructions that when executed by a computer enable the computer to implement a method including:

detecting an actual object;

determining at least one of an orientation of a first image to be projected and a position thereof within a projection surface, based on at least one of an orientation and a position of the detected actual object; and

projecting the first image onto the projection surface in the determined position and/or determined orientation.

### Supplementary Note 16

The non-transitory computer-readable storage medium according to supplementary note 15, including:

detecting an edge included in a circumference of the actual object; and

determining at least one of the orientation of the first image and the position thereof within the projection surface, based on at least one of an orientation and a position of the detected edge.

### Supplementary Note 17

The non-transitory computer-readable storage medium according to supplementary note 15, wherein

the actual object is a user close to the projection surface, and including:

detecting an edge which is included in a circumference of the projection surface and is close to the user; and

determining the orientation of the first image and the position thereof within the projection surface, based on at least one of an orientation and a position of the detected edge.

### Supplementary Note 18

The non-transitory computer-readable storage medium according to supplementary note 15, including determining the orientation of the first image based on an extending direction of a line connecting the position of the projected first image and a reference point on the projection surface.

### Supplementary Note 19

The non-transitory computer-readable storage medium according to supplementary note 15, wherein

the actual object is an operation body of a user, and the method further comprising determining the orientation of the first image to be projected, based on an extending direction of the operation body.

### Supplementary Note 20

A non-transitory computer-readable storage medium storing instructions that when executed by a computer enable the computer to implement a method including:

projecting a first image onto a projection surface;

detecting a user operation;

determining an orientation of the first image to be projected, based on a movement direction of a position on which the first image is projected.

### Supplementary Note 21

The non-transitory computer-readable storage medium according to supplementary note 20, including:

calculating a time-averaged movement speed of the first image; and

determining the orientation of the first image to be projected, based on a direction indicated by the calculated average movement speed.

1. An information processing system comprising:
a memory storing instructions; and
at least one processor configured to process the instructions to:
detect an actual object;
determine at least one of an orientation and a position of a first image within a projection surface, based on at least one of an orientation and a position of the actual object; and
project the first image onto the projection surface in at least one of the determined position and the determined orientation.

2. The information processing system according to claim 1, wherein the at least one processor is configured to process the instructions to:
detect an edge included in a circumference of the actual object; and
determine at least one of the orientation and the position of the first image within the projection surface, based on at least one of an orientation and a position of the detected edge.

3. The information processing system according to claim 1, wherein
the actual object is a user, and
wherein the at least one processor is configured to process the instructions to:
detect an edge which is included in a circumference of the projection surface; and
determine at least one of the orientation and the position of the first image within the projection surface, based on at least one of an orientation and a position of the detected edge.

4. The information processing system according to claim 1, wherein the at least one processor is configured to process the instructions to determine the orientation of the first image based on an extending direction of a line connecting the position of the projected first image and a reference point on the projection surface.

5. The information processing system according to claim 1, wherein
the actual object is an operation body of a user, and
wherein the at least one processor is configured to process the instructions to determine the orientation of the first image, based on an extending direction of the operation body.

6. An information processing system comprising:
a memory storing instructions; and
at least one processor configured to process the instructions to:
project a first image onto a projection surface;
detect a user operation; and
determine an orientation of the first image, based on a movement direction of a position on which the first image is projected.

7. The information processing system according to claim 6, wherein the at least one processor is configured to process the instructions to:
calculate a time-averaged movement speed of the first image; and
determine the orientation of the first image, based on a direction indicated by the calculated average movement speed.

8. An information processing method comprising:
detecting an actual object;
determining at least one of an orientation and a position of a first image within a projection surface, based on at least one of an orientation and a position of the actual object; and
projecting the first image onto the projection surface in at least one of the determined position and determined orientation.

9. The information processing method according to claim 8, comprising
detecting an edge included in a circumference of the actual object; and
determining at least one of the orientation and the position of the first image within the projection surface, based on at least one of an orientation and a position of the detected edge.

10. The information processing method according to claim 8, wherein
the actual object is a user, and the method further comprising:
detecting an edge which is included in a circumference of the projection surface; and
determining at least one of the orientation and position of the first image within the projection surface, based on at least one of an orientation and a position of the detected edge.

11. The information processing method according to claim 8, comprising determining the orientation of the first image based on an extending direction of a line connecting the position of the projected first image and a reference point on the projection surface.

12. The information processing method according to claim 8, wherein
the actual object is an operation body of a user, and the method further comprising determining the orientation of the first image to be projected, based on an extending direction of the operation body.

13. An information processing method comprising:
projecting a first image onto a projection surface;
detecting a user operation; and
determining an orientation of the first image, based on a movement direction of a position on which the first image is projected.

14. The information processing method according to claim 13, comprising:
calculating a time-averaged movement speed of the first image; and
determining the orientation of the first image, based on a direction indicated by the calculated average movement speed.

15. The information processing system according to claim 1, comprising a projector that adjusts the position of the first image by changing at least one of the direction and position of projected light.

16. The information processing system according to claim 15, comprising a monitor that detects the actual object.

17. The information processing system according to claim 15, wherein the projector adjusts the position of the first image in accordance with the detected user's operation.

18. The information processing system according to claim 1, wherein the projector adjusts the position of the first image by masking at least part of projecting light.
